(19) United States
(12) Patent Application Publication
(10) Pub. No.: US 2004/0066888 A1
(43) Pub. Date: Apr. 8, 2004

(54) X-ray examining device, and its control method and its adjusting method

(76) Inventors: Koichi Omori, Toyonaka-shi (JP); Toshikazu Yoneda, Toyonaka-shi (JP); Moriaki Kawasaki, Suita-shi (JP); Yoshihiro Ino, Kawanishi-shi (JP); Hiroshi Nakashima, Kanazawa-shi (JP); Hisahide Ishino, Tatsunokuchimachi (JP); Sueki Baba, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/433,421

(22) PCT Filed: Nov. 20, 2002
(86) PCT No.: PCT/JP02/12119

(30) Foreign Application Priority Data
Nov. 26, 2001 (JP) 2001-359240

(51) Int. Cl. G01N 23/04

(52) U.S. Cl. 378/57

(57) ABSTRACT

A plurality of X-ray detection means is moved in the location relative to an object of inspection whose place has been fixed at a certain specific location. Corresponding to positioning of the detection means, X-ray irradiation means is made to move, to make either a location shift or a revolution. A plurality of data on fragmental radioscopic images thus generated is integrated into a synthesized picture. An X-ray inspection apparatus in accordance with the present invention is compact in the overall dimensions, yet exhibits a superior performance needing a shorter time before a picture is displayed after it is detected.

### TECHNICAL FIELD

The present invention relates to an X-ray inspection apparatus which irradiates an object of inspection with X-ray and displays the radioscopic image on a display. The present invention also discloses a method of controlling the apparatus and a method of adjusting the apparatus.

### BACKGROUND ART

In a conventional X-ray inspection apparatus, there has been two possible methods for displaying an entire view of an object of inspection whose size is exceeding a scope of inspection range provided by the apparatus.

One method is: Shifting the location of X-ray irradiation means and X-ray detection means in relation to an object of inspection for generating a plurality of data on fractional radioscopic images of the object of inspection, and then integrating the plurality of data to reproduce a synthesized image representing the whole picture. The other method, although the method can only provide a picture of a deteriorated grade in resolution, is: Disposing X-ray irradiation means and X-ray detection means away from an object of inspection, for generating an entire picture.

FIG. 6 shows the structure of a conventional X-ray inspection apparatus. The apparatus comprises X-ray generation source 101, collimator 102 for regulating the spread of generated X-ray beam, X-ray beam 103, shielding board 104, object of inspection 105, X-Y table 106 for shifting the location of object of inspection, X-ray sensor 107 which being the means for detecting X-ray, X-ray image capture unit 108, personal computer 109, display unit 110 for displaying radioscopic image, X-ray control unit 111, cabinet 112, etc.

The above-configured conventional X-ray inspection apparatus faces following tasks when the size of an object of inspection is greater than a scope of inspection range made available by the detection means.

Namely, it is requested to display a whole picture of an object of inspection at a high resolution level, which picture would be obtained by integrating a plurality of fractional radioscopic images whose data had been made available by moving the X-ray irradiation means and the X-ray detection means relative to the object of inspection. At the same time, it is requested to reduce the total image processing time from detection to display, to make the overall dimensions of apparatus smaller, and to lower the cost.

### DISCLOSURE OF INVENTION

An X-ray inspection apparatus in accordance with the present invention comprises X-ray irradiation means for irradiating an object of inspection with X-ray, at least one detection means for detecting X-ray generated by said X-ray irradiation means, and transfer means for transferring said detection means. The transfer means transfers said detection means within a range that corresponds to the area of object of inspection.

An X-ray inspection apparatus in accordance with the present invention comprises X-ray irradiation means for irradiating an object of inspection with X-ray, at least one detection means for detecting X-ray generated by said X-ray irradiation means, transfer means for transferring said detection means, a plurality of drive control means for controlling said plurality of detection means, each of said plurality of detection means being coupled with drive control means, synchronization means for synchronizing operations of said plurality of drive control means, at least one signal processing means for inputting signals delivered from said plurality of detection means via said plurality of drive control means, and image synthesizing means for synthesizing a picture based on process signal delivered from said plurality of signal processing means.

A method of controlling an X-ray inspection apparatus in accordance with the present invention comprises the steps of irradiating an object of inspection with X-ray, and detecting the X-ray irradiated on the object of inspection using at least one detection means, said step of detection is conducted by transferring said detection means so as to cover at least a range that corresponds to an area of object of inspection.

The present invention further offers a method of adjusting an X-ray inspection apparatus, which inspection apparatus comprising X-ray irradiation means for irradiating an object of inspection with X-ray, a plurality of detection means for detecting the X-ray generated by said X-ray irradiation means and transfer means for transferring said detection means. The adjusting method comprises the steps of; aligning arrangement of pixels constituting effective X-ray detection portion of a first detection means with direction of the shift, and then making arrangement of pixels constituting effective X-ray detection portion of other detection means to coincide with the arrangement of pixels constituting effective X-ray detection portion of said first detection means.

### BRIEF DESCRIPTION OF THE DRAWINGS

FIG. 1 shows the structure of an X-ray inspection apparatus in accordance with an exemplary embodiment of the present invention.

FIG. 2 is a perspective view showing the mechanical unit of an X-ray inspection apparatus in accordance with an exemplary embodiment of the present invention.

FIG. 3 shows a scanning pattern in an X-ray inspection apparatus in accordance with an exemplary embodiment of the present invention.

FIG. 4 is a flow chart covering the operations from the Power ON to Ready, in an X-ray inspection apparatus in accordance with an exemplary embodiment of the present invention.

FIG. 5 is a flow chart covering the operations from the Ready to actual imaging work by tiling, in an X-ray inspection apparatus in accordance with an exemplary embodiment of the present invention.

FIG. 6 shows the outline structure of a conventional X-ray inspection apparatus.

### DETAILED DESCRIPTION OF PREFERRED EMBODIMENT

In an X-ray inspection apparatus in accordance with the present invention, an object of inspection is disposed fixed at a place, while a plurality of X-ray detection means is moved in the location relative to the object of inspection. In accordance with a location where the detection means is situated, an X-ray irradiation means makes at least either one of the following motions, location shift and swivel action. Based on a plurality of data of fractional penetration images thus made available, a high resolution picture showing an entire picture is synthesized.

Since X-ray detection means, which is a relatively small member of an inspection apparatus, is moved in the present invention, the overall dimensions of an inspection apparatus becomes smaller as compared with that in which a bulky object of inspection is moved. Furthermore, a larger area of detection is provided in the present invention, because of the use of a plurality of X-ray detection means. This leads to a shorter time needed to provide a synthesized image, and to the display of an entire picture at a high resolution level.

Now in the following, exemplary embodiments of the present invention are described with reference to the drawings. The drawings are intended to offer the concept of invention; they are not intended to represent absolute dimensions or relative positioning among the constituent components at precise scale.

(Exemplary Embodiment)

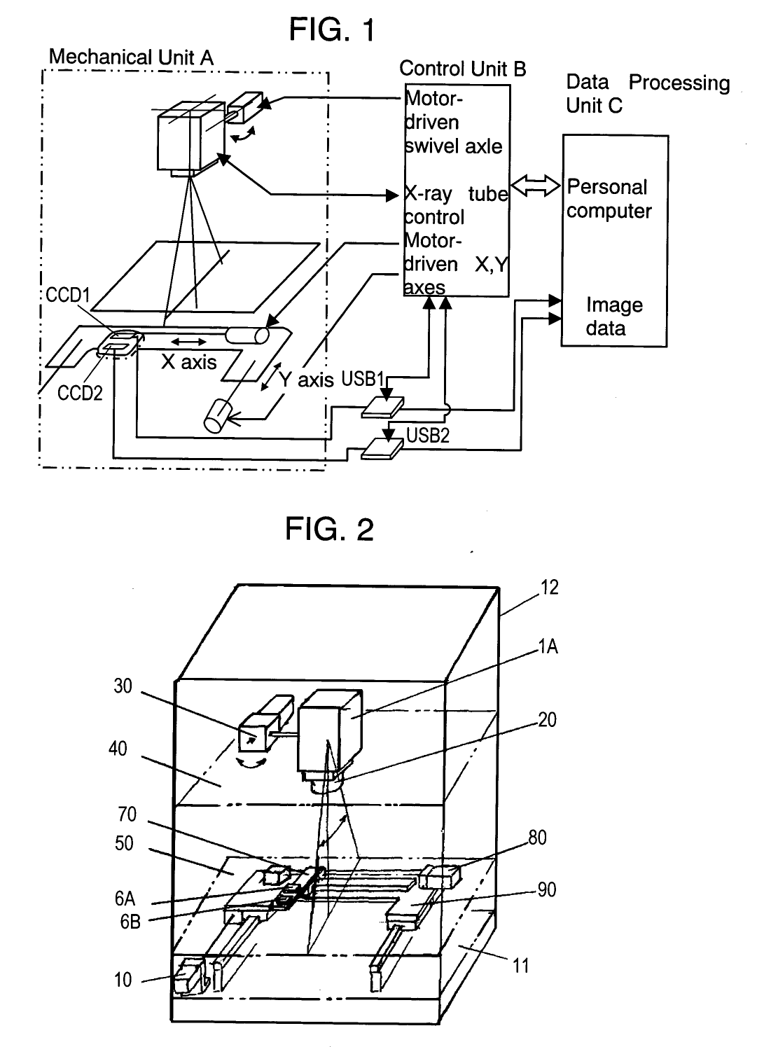

Referring to FIG. 1, a mechanical unit A has a function for irradiating an object of inspection with X-ray, a function which detects the X-ray, and a sensor driving gear for moving the location of the detection sensor.

A control unit B controls X-ray tube in the X-ray irradiation, motor in the revolution of X-ray tube revolving axle, and respective motors for shifting the X axis and Y axis.

A data processing unit C, in which a personal computer is used, handles signal exchange between the mechanical unit A and the control unit B coupled via USB 1 and USB 2. The image data made available are processed there into a synthesized picture of X-ray penetration. The X-ray sensor for detecting X-ray uses a CCD sensor. In FIG. 1, CCD1 and CCD2 denote the X-ray sensor. Referring to FIG. 2, X-ray generated at X-ray tube unit 1A proceeds penetrating through stage 50, on which an object of inspection is placed, and reaches X-ray sensors 6A and 6B.

X-ray sensors 6A and 6B are disposed on a sensor holder, and then mounted altogether on X axis table 70. X axis table 70 can travel along the X axis direction by the action of X axis driving motor 80. Y axis table 90 can travel along the Y axis direction by the action of Y axis driving motor 10, on which motor a Y axis driving unit is placed. These units are installed on sensor unit stage 11, so as to cover the entire area of an object for inspection. In the mean time, X-ray tube unit 1A makes a swivel action synchronized with motion in the direction of X axis, by the action of motor unit 30 for revolving the axle of X-ray tube unit mounted on X-ray tube unit stage 40. The irradiating position is thus shifted.

The above descriptions are based on a case where the number of X-ray sensors is 2, or n=2 (distance between the detection sensors being twice as long the effective length of detection). In this structure, the X-ray irradiation covers the entire region in terms of Y axis direction, while the irradiation is scanned only in terms of X axis direction. The same principles used in scanning X-ray tube in the X axis and the Y axis, driving a motor for the location shift and swivel action, etc. apply also to other arrangements where, for example, more than two X-ray sensors are employed. When the X-ray sensor is used for two units, the distance between detection sensors is adjusted by means of a holder to be approximately twice as long the effective length of detection. The holder is movable in either of the directions; X, Y and the horizontal revolution. An inspection jig with markers at 3 points is used for the adjustment.

The inspection jig is mounted and fixed on a holder at a certain specific place. The marker position can be detected when each sensor is X-ray irradiated.

Thus, the inspection jig and places of respective sensors mounted on holder becomes recognizable. Positioning of the two sensors can be determined by aligning them into coincidence with respect to the X axis direction, the Y axis direction and the revolution direction. Data on radioscopic images are made available by the sensors thus aligned to right positioning.

Now in the following, description is made on an exemplary method how to make image data available for an object of inspection, the size of which is exceeding a scope of detection by inspection means. Namely, an example of tiling is described.

Suppose an Mv instruction (instruction to move) is given for an amount of shift in X axis direction a=5 (tiles), an amount of shift in Y axis direction b=5 (tiles), it operates as follows:

(1) From the starting point, it moves for “a” times in the positive direction along X axis at 1-tile pitch.

(2) It moves for one time in the positive direction along Y axis at 1-tile pitch.

(3) Number of the Y shifts b=b−1, and code of the X shift is changed. (b=4)

(4) It moves for “a” times in the negative direction along X axis at 1-tile pitch.

(5) It moves for 3 times in the positive direction along Y axis at 1-tile pitch.

(6) Number of the Y shifts b=b−3, and code of the X shift is changed. (b=1)

(7) It moves for “a” times in the positive direction along X axis at 1-tile pitch.

(8) It moves in the positive direction along Y axis at a pitch of 1-tile, for 1 time.

(10) Number of the Y shifts b=b−1, and code of the X shift is changed. (b=0)

(11) It moves for “a” times in the negative direction along X axis at 1-tile pitch.

(12) The axis shift completes. (outputs in the status)

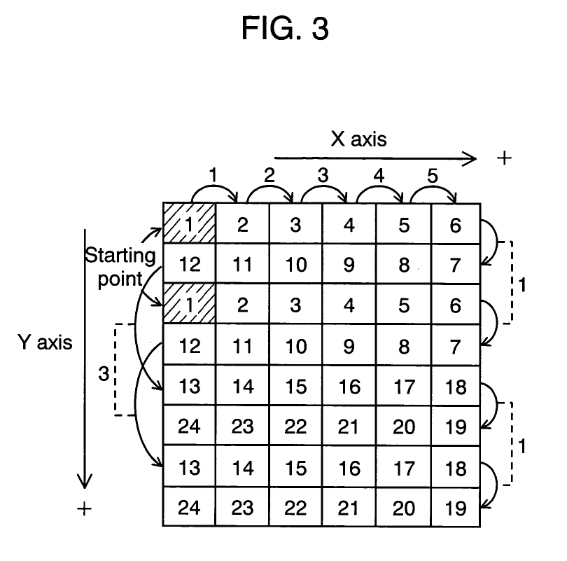

The scan pattern is shown in FIG. 3.

The positive direction of an axis means the direction as indicated with an arrow mark in FIG. 3, the negative direction means the reverse direction.

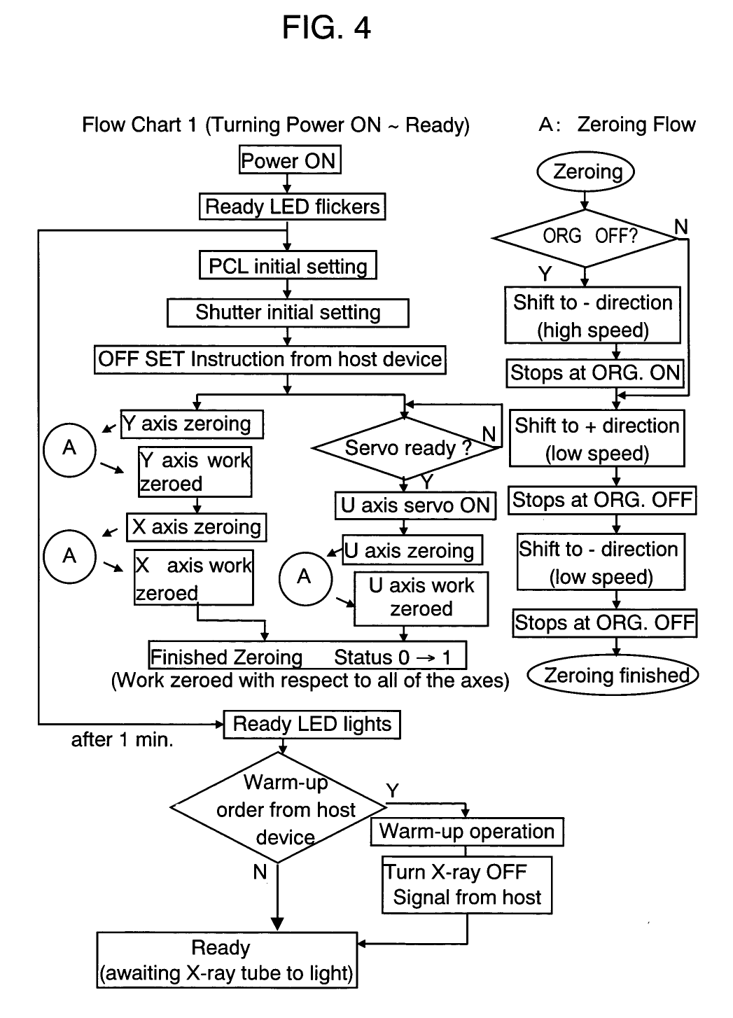

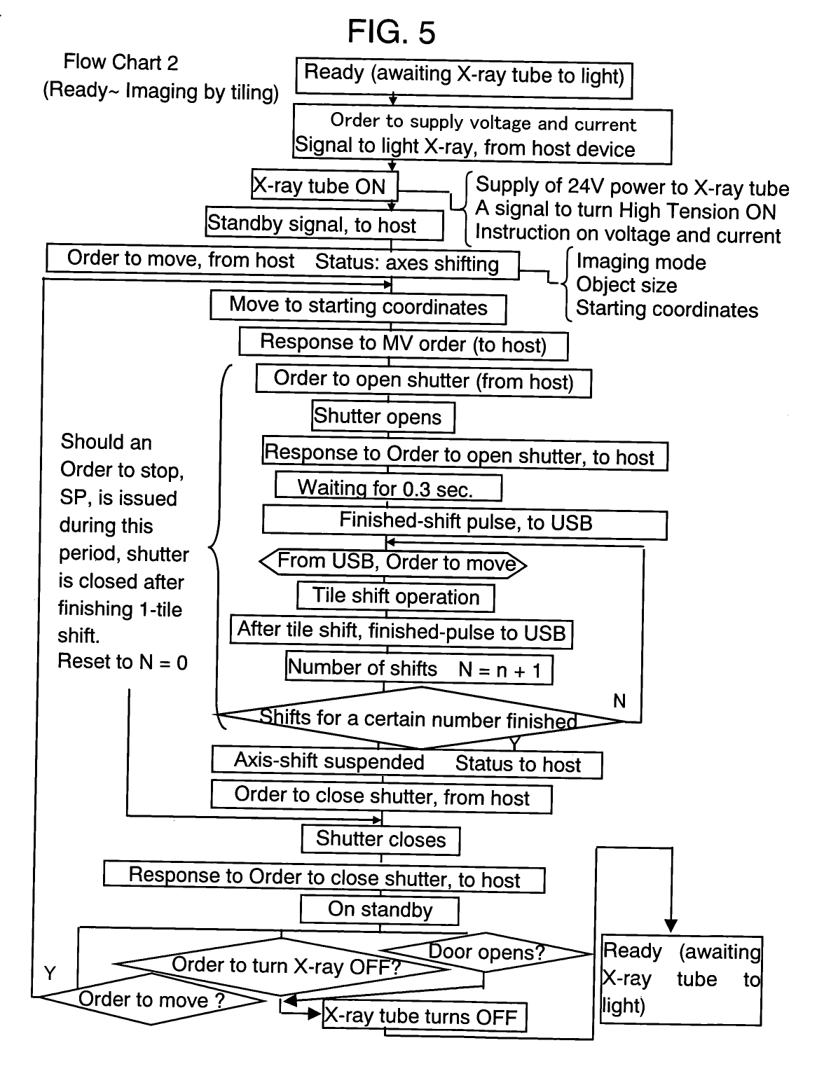

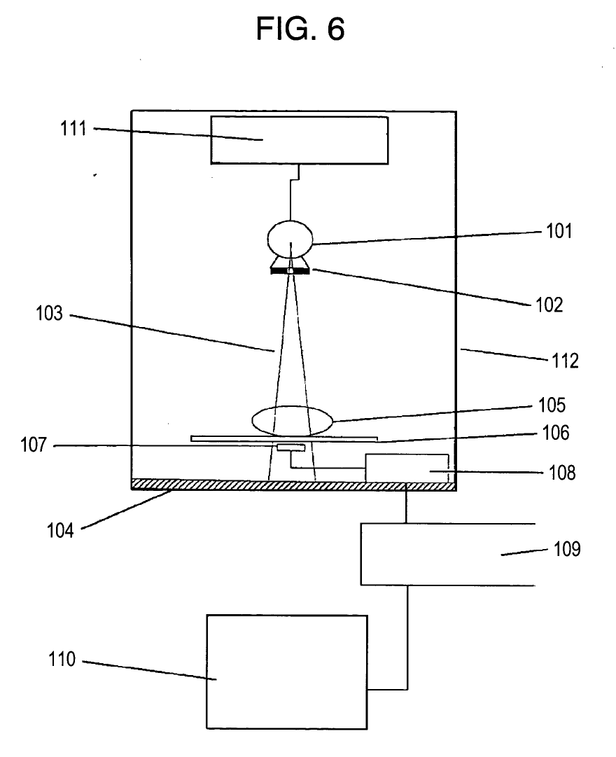

The operation of the present apparatus is as shown in FIG. 4, Flow chart 1, and FIG. 5, Flow chart 2. Depending on the size of an object of inspection, only one sensor among the two sensors may be used.

### INDUSTRIAL APPLICABILITY

In an X-ray inspection apparatus in accordance with the present invention, the X-ray detection sensor, which being a relatively small constituent member, is moved instead of moving a bulkier object of inspection. This means that the overall dimensions of apparatus can be made smaller. Furthermore, it uses a plurality of X-ray detection means; as a result, an area of detection becomes larger. Consequently, the time needed before the data are displayed in the form of a synthesized picture can be reduced. Thus the present invention offers a low cost X-ray inspection apparatus without sacrificing the high resolution capability.

1. An X-ray inspection apparatus comprising
X-ray irradiation means for irradiating an object of inspection with X-ray,
at least one detection means for detecting the X-ray generated by said X-ray irradiation means, and
transfer means for transferring said detection means, wherein
said transfer means transfers said detection means within a range corresponding to an area of object of inspection.

2. The X-ray inspection apparatus of claim 1, wherein
said plurality of detection means is disposed at a certain specific interval, and is moved simultaneously.

3. The X-ray inspection apparatus of claim 2, wherein
said certain specific interval between each other of the plurality of detection means corresponds to approximately n times (n: a natural number) the effective detection length of respective detection means.

4. The X-ray inspection apparatus of claim 2 or claim 3, wherein
distance of transfer at said transfer means is determined, corresponding to an arrangement of said plurality of detection means, so that it sufficiently covers a plane of inspection while an overlapping is minimized.

5. The X-ray inspection apparatus recited in one of claims 1 through 4, wherein
said transfer means makes said X-ray irradiation means to perform, corresponding to position arrangement of said plurality of detection means, at least one operation of the location shift and the revolution.

6. An X-ray inspection apparatus comprising
X-ray irradiation means for irradiating an object of inspection with X-ray,
at least one detection means for detecting the X-ray generated by said X-ray irradiation means,
transfer means for transferring said detection means,
a plurality of drive control means for controlling said plurality of detection means, each of said plurality of detection means is coupled with respective drive control means,
synchronous means for synchronizing the operation among said plurality of drive control means,
at least one signal processing means which inputs signals from said plurality of detection means via said plurality of drive control means, and
image synthesizing means which inputs processing signal from said plurality of signal processing means for integrating the signal into a synthesized image.

7. A method of controlling an X-ray inspection apparatus comprising the steps of
irradiating an object of inspection with X-ray, and
detecting the X-ray irradiated on object of inspection using at least one detection means, wherein
said step of detection comprises a detection step in which said detection means conducts a detection by shifting the location at least within a range corresponding to an area of object of inspection.

8. The method of controlling an X-ray inspection apparatus having said plurality of detection means recited in claim 7, the transfer means used wherein transfers said plurality of transfer means so that they sufficiently cover a plane of inspection while an overlapping is minimized.

9. A method of adjusting an X-ray inspection apparatus, which apparatus comprising X-ray irradiation means for irradiating an object of inspection with X-ray, a plurality of detection means for detecting the X-ray generated by said X-ray irradiation means and transfer means for transferring said detection means, comprising the steps of
putting arrangement of pixels constituting effective X-ray detection portion of a first detection means into the same direction as the shift direction, and then
putting arrangement of pixels constituting effective X-ray detection portion of other detection means and that of pixels constituting effective X-ray detection portion at said first detection means into coincidence.

10. The method of adjusting an X-ray inspection apparatus recited in claim 9, wherein
said certain specific interval between each other of the plurality of detection means corresponds to approximately n times (n: a natural number) the effective X-ray detection length of respective detection means.
